(19) United States
(12) Patent Application Publication
(10) Pub. No.: US 2007/0176023 A1
(43) Pub. Date: Aug. 2, 2007

(54) SPRAY DEVICE

(76) Inventors: William Peter Herring, Bath (GB); James Moore, Frome (GB)

Correspondence Address: STITES & HARBISON PLLC, 1199 NORTH FAIRFAX STREET, SUITE 900, ALEXANDRIA, VA, 22314, US

(21) Appl. No.: 11/669,982

(22) Filed: Feb. 1, 2007

(30) Foreign Application Priority Data
Feb. 2, 2006 (GB) 0602136.4

(51) Int. Cl. B05B 7/04; B05B 7/10; B05B 7/12

(52) U.S. Cl. 239/398; 239/399; 239/407

(57) ABSTRACT

A side spray has a hand-held spray unit connected via a manifold to two fluid input supplies. The manifold converts the two separate input supplies into a joint output supply, in which a first fluid feed is partitioned from a second fluid feed. The first and second fluid feeds are supplied to first and second input ports respectively of a mixing chamber located in the spray unit. Upon actuation of the side spray, fluid from the first and second fluid feeds can mix in the mixing chamber in the spray unit before being output. The mix ratio of the first and second fluid feeds may be adjustable.

### FIELD OF THE INVENTION

The present invention relates to hand sprays used e.g. on kitchen sinks as alternative or additional water sources to the main tap or faucet.

### BACKGROUND OF THE INVENTION

Typical hand sprays (also known as side sprays) include a spray head, e.g. similar to a shower head, for delivering fluid (e.g. water) flow through a nozzle. Traditionally, the hand sprays are located next to the primary tap or taps of a kitchen sink. Side sprays are commonly used with mixer taps. The spray head typically included a hand grip to allow the user to direct the flow as desired. Some hand sprays are removably mountable on the work surface (sink holding or containing surface) and have a flexible fluid delivery hose to allow more freedom of movement. Typically, known hand sprays are operable using a simple thumb switch, which controls a valve to stop or release fluid flow through the nozzle. The thumb switch allows controlled one-handed operation.

Early hand sprays were connected to a single source, e.g. the cold water supply pipe for the primary tap. The lack of control over hand spray output temperature was undesirable, so a number of proposals to provide mixed (e.g. hot and cold) water, preferably controllably mixed water, at the hand spray were made.

In one proposal an automatic diverter valve is incorporated into a mixer tap. The diverter valve operates to deflect mixed water into the hand spray when the hand spray is operated. To fit in the mixer tap, the automatic diverter was small, which meant that in time it was liable to become clogged with limescale and therefore reduce flow to the spray.

Automatic diverters made the use of bridge mixer taps difficult. To address this, GB 2361047 proposed a bridge mixer tap with a mixer chamber separate from the traditional mixer passageway between tap pillars. The extra mixer chamber is located under the work surface, where it is fed by hot and cold water supplies controllable by valves (also located under the work surface) operable by the tap operators on each pillar. The mixing chamber possesses two outputs: one feeds a hand spray via a flexible conduit, the other sends mixed water up through both pillars to be ejected from the main tap spout. A valve in the mixing chamber shuttles between two positions according to pressure differential experienced in the mixing chamber (due to operative status of the hand spray) to direct flow through a respective one of the outputs. In this arrangement, long operator shafts are required to extend down the pillars to their respective valves, and the visible mixing passageway is redundant because the water is already mixed when it reaches that passageway.

GB 2394525 proposed a bridge mixer tap with a built in diverter valve in the traditional bridge mixing chamber (above the work surface). The diverter valve diverts mixed flow down a passageway coaxial with one of the pillar input supplies so that it flows back beneath the work surface after mixing, where it is sent through a flexible conduit to feed a hand spray device. However, this increases the complexity of the tap units. For example, the size of the bridge mixer may be enlarged to house the diverter valve. The temperature of the mixed water is controlled by the tap operators on the pillars.

### BRIEF SUMMARY OF THE INVENTION

The invention provides a side spray with a mixing chamber in its spray head.

### BRIEF DESCRIPTION OF THE DRAWINGS

FIG. 1 shows a side view of a spray device which is an embodiment of the invention;

FIG. 2 shows a front view of a spray device which is an embodiment of the invention;

FIG. 3 shows a cross-sectional view taken along line A-A in FIG. 1;

FIG. 4 shows a cross-sectional view taken along line B-B in FIG. 2;

FIG. 5 shows a close-up cross-sectional view of the manifold of FIG. 1 along line C-C of FIG. 1.

### DETAILED DESCRIPTION OF THE INVENTION

The invention aims to ameliorate one or more of the problems associated with known side spray devices.

In one embodiment, the invention may provide an integrated side spray device where mixing control and flow control are both provided by the device itself.

A single control on the device may be provided for regulating the mixing ratio and output fluid flow rate from the device. The invention may also provide a manifold to supply liquid to the device in a compartmentalized (e.g. separated) manner.

The invention may eliminate the need for a mixing chamber located outside the spray head.

The invention is preferably for use with kitchen sink side sprays, e.g. hand sprays mountable next to, typically on the same surface as, a main kitchen tap.

According to one aspect of the invention, there may be provided a spray device for delivering a user-directable output fluid flow, the spray device having a spray unit detachably mountable on (above) a work surface and a fluid supply arranged to deliver fluid to the spray unit, the fluid supply including first and second fluid feeds, wherein the spray unit includes a mixing chamber which has first and second input ports connected to the first and second fluid feeds respectively and an output port, whereby fluid received in the mixing chamber from the input ports is mixed before exiting through the output port.

Preferably, the device includes a mix controller arranged to control the mixing ratio of fluid receivable in the mixing chamber from the first and second input ports such that fluid received from the first and second input ports may be mixed in varying (adjustable) amounts in the mixing chamber before exiting via the output port to form the output fluid flow. Preferably, the spray unit consists of a spray head and a handle. The mixing chamber may be formed within the spray head. Preferably, the spray device (e.g. spray head) has an output spray nozzle which is connected to the output port of the mixing chamber.

Preferably, the mix controller is a rotary valve arranged to vary the relative fluid flows received in the mixing chamber from the first and second input ports. The rotary valve may therefore adjust the mixing ratio of fluid from the first and second input ports received in the mixing chamber. Preferably, the rotary valve is movable to a fluid shut off position wherein the first and second input ports are isolated from the mixing chamber. The mix controller may include a user-adjustable actuator, e.g. rotatable knob or lever, arranged to move the rotary valve. The actuator may be mounted on the spray head, e.g. in a position accessible for a user's thumb when holding the handle.

The mix controller may control the relative proportion of fluid from each fluid input supply permitted into the mixing chamber. The mix controller preferably controls the input from a plurality of, e.g. two, typically hot and cold, input supplies to the mixing chamber. Preferably, the mix controller is arranged to operate a mixer valve to control relative proportions of fluid received in the mixing chamber from separate input supplies. For example, the mix controller may be able to direct 100% hot water or 100% cold water or a mixture of the two into the mixing chamber. Preferably, the mix controller is arranged to vary the input proportions in a continuous, e.g. linear, fashion.

The mixer valve may be conventional. Preferably, the actuator is operably coupled to a rotatable tube, which may act as a barrier between the fluid input supplies and a mixing space for mixing the inputs. The tube may include a slot or slots e.g. a radial inlet hole formed therein arranged to align with input supply ports according to the rotation of the tube, to permit fluid from the input supply port(s) into the mixing space. Although rotational operation is described and preferred because it matches the movement typically required to operate a valve or, other types of operation, e.g. axial pull up/push down arrangements are feasible.

Preferably, the spray unit includes a flow controller arranged to control output fluid flow. The flow controller may include a stop valve urged to close a fluid communication path through the spray device. The flow controller may include a spring loaded actuator, e.g. to operate the stop valve to permit an output fluid flow. The flow controller is preferably arranged as an on/off device to either permit or prevent output fluid flow from the spray head. The flow controller may include a axially movable stop valve. The rotary valve may be operable by a spring loaded actuator e.g. located on the spray head of the spray device and actuable by the user's thumb when the user holds the spray head. The stop valve may be of the conventional type. Thus, while the flow controller may be operable to allow fluid to flow through the device e.g. open/close device, the mix controller may be operable to control the proportions of flow inputs into the mixing chamber, i.e. the mix controller may control the content of the output fluid flow from the device. As explained above, the mix controller may also perform the function of the flow controller in that it may be operable to prevent fluid from entering the mixing chamber.

Preferably, the flow controller is combined with the mix controller. The user may then operate the device by manipulating a single control element. For example, mixing control may be controlled through rotation and output flow rate by push button or vice versa.

In this preferred case, the spray device has a combined controller operable to control fluid flow into and away from the mixing chamber. The combined controller is preferably located on the spray head, e.g. fluid flow into the mixing chamber and output fluid flow from the spray head are operable using a thumb switch. Preferably, rotation of the thumb switch controls a mixing ratio of fluid flow into the mixing chamber and depression of the thumb switch controls output fluid flow from the spray head.

Preferably, the fluid supply is connected to a manifold which is arranged to supply independent (e.g. separate) fluid input flows to the first and second fluid feeds. Preferably the manifold is located below the work surface. Elements of the spray device on display may thereby be kept to a minimum. This may minimize the visible footprint of the spray device, which may make it more aesthetically pleasing. The first and second fluid feeds may be transferred from the manifold to the spray unit in a flexible conduit. Preferably, each of the first and second fluid feeds is a flexible tube in fluid communication with its respective input port at the mixing chamber. The manifold may be connected to a mains water supply. Preferably, the first and second fluid feeds comprise a compartmentalized (e.g. separated or partitioned conduit. The compartmentalized conduit may have a first compartment which envelopes a second compartment. A coaxial feed arrangement is preferred.

Preferably, the spray unit is mountable on a housing which is fixed to the work surface e.g. a kitchen sink or shelf. The flexible conduit may be extendible, or its length may be so selected to allow the spray unit to be moved away from the housing. Preferably, the flexible conduit lies substantially below the work surface when the spray unit is resting in its housing. A single hole may be formed in the work surface for the flexible conduit feeding the spray unit to pass through. The housing may have a through hole formed therein for locating over said hole in the work surface, thereby allowing the flexible conduit to pass through.

The spray device may be provided as a supplementary device to a main tap or faucet e.g. for use on a kitchen sink. In other words, the spray device is a distinct entity from a main fluid outlet, such as a mixer tap. The spray device may be mounted on the same surface as the main tap. Alternatively, the spray device may be provided as a stand-alone device, e.g. with its own separate sink.

Thus, in another aspect of the invention, the spray device may be provided as part of a mixer tap assembly e.g. kitchen tap assembly having a mixer tap comprising a mixing chamber independent of the spray device. In a preferred embodiment the spray device is a hand spray.

Preferably, the manifold provides the separate fluid supplies for the compartmentalized conduit of the fluid supply. A compartmentalized conduit may be a single tube (the cross-section of the tube not necessarily being cylindrical) containing two or more independent (e.g. separate) compartments, internal passageways open at either end running along the length of the tube, each of which allows fluid to flow through the tube without mixing.

Preferably, the compartmentalized conduit comprises two compartment feed, e.g. a tube (the cross-section of the tube not necessarily being cylindrical) containing two compartments (passageways) open at either end running along the length of the tube, which allow two fluids to flow through the tube without mixing.

In one embodiment, one of the compartments of the two compartment feed runs along the length of the tube enveloped by (contained within) the other compartment of the two compartment feed, e.g. in a coaxial manner.

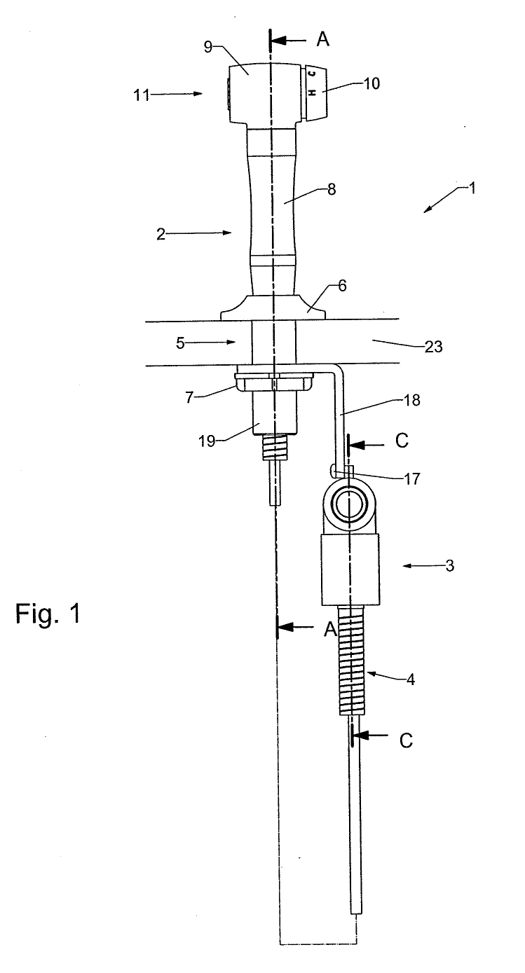

FIG. 1 shows a spray device 1 which comprises two sections: a manifold 3 and a spray unit 2. A flexible fluid supply 4 connects the manifold 3 with the spray unit 2. The spray unit 2 comprises a handle 8 for the user to grip and a spray head 9 mounted on the handle 8. The spray head 9 comprises a spring loaded actuator 10. The spring loaded actuator 10 controls fluid flow through a nozzle 11 of the spray head 9 as well as the temperature (hot/cold mix ratio) of the fluid flowing through the nozzle 11.

The spray head is removably mounted in a deck flange 6 of a housing 5. The housing 5 is mounted on a work surface 23, where it is secured in place using a back nut 7. The housing 5 comprises a hollow shaft 19 that sits in a hole formed through the work surface 23. The deck flange 6 prevents the housing 5 from slipping through the hole.

The manifold 3 is located under the work surface 23, e.g. out of sight of the user. The position of the manifold 3 is secured by a plate 18, which describes a right angle. The horizontal part of the plate 18 is fixed to the underside of the work surface 23 by the back nut 7 and the manifold is fixed to the vertical part of the plate 18 by two screws 17.

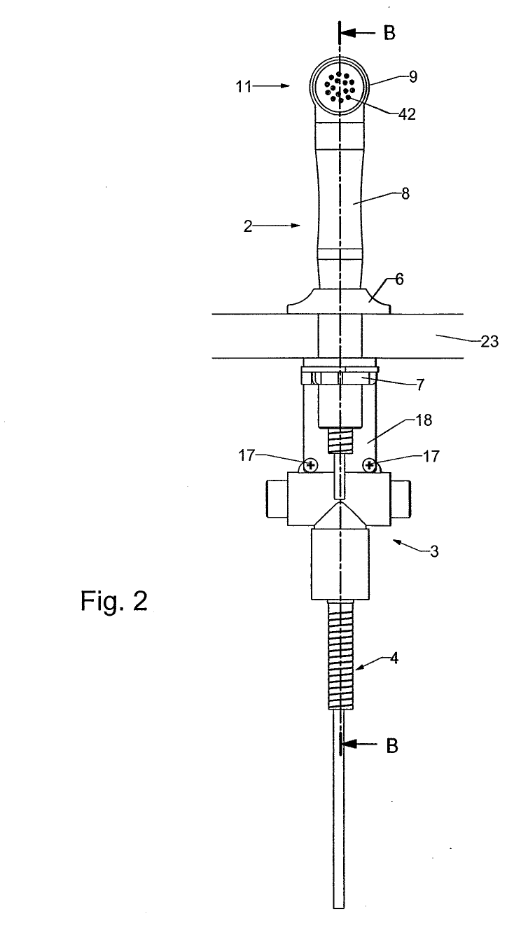

FIG. 2 shows the holes 42 in the nozzle 11 through which output fluid flow exits the spray head 9 when the spring loaded actuator 10 is depressed. The two screws 17 securing the manifold to the plate 18 are shown.

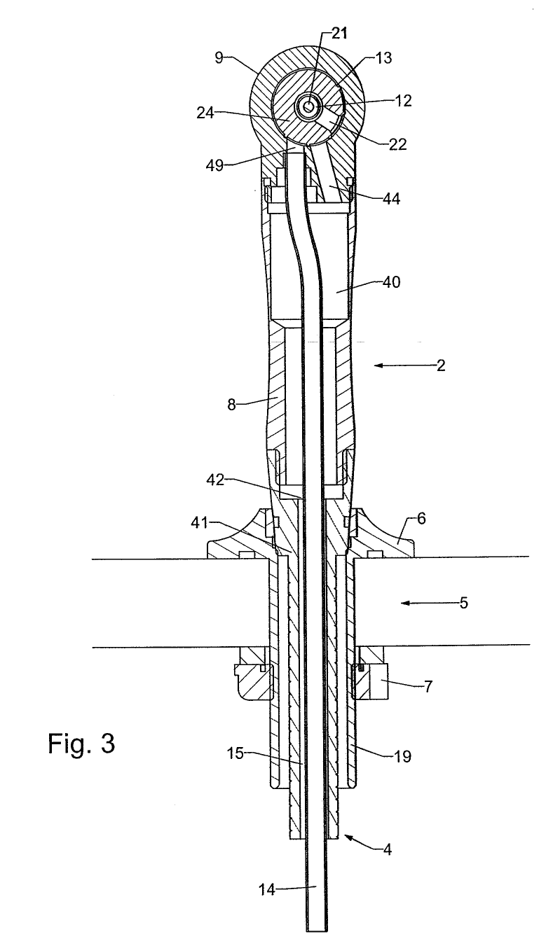

FIG. 3 shows a cross-sectional view of the spray head 2, which illustrates its inner workings. The flexible fluid supply 4 is connected to the handle 8 at a port 41. Fluid supply 4 comprises two fluid feeds 14, 15, which extend through the port 41 into the handle 8. A first fluid feed 15 is connected to a collection chamber 40 at a port 42. The collection chamber 40 is connected via a first input port 44 to the spray head 9.

A second fluid feed 14 extends through the collection chamber 40 and is connected via a second input port 49 to the spray head 9.

A rotary valve 13 rotatably mounted in the spray head 9 consists of a valve body 24 with a central mixing chamber (space) 12, which has a radial inlet 22. The rotary valve 13 controls the relative proportion of fluids that enters the mixing chamber 12 from the first and second input ports 44, 49 according to the overlap between the radial inlet 22 and the input ports 44, 49. The rotary valve 13 is rotatable from an off position (no overlap), in which no fluid enters the mixing chamber 12 from the first and second input ports 44, 49, through a full cold position (full overlap with port 44) where all the fluid entering the mixing chamber is from the cold supply of the first input port 44, to a full hot position (full overlap with port 49) where all the fluid entering the mixing chamber 12 is from the hot supply of the second input port 49. Between the full cold and the full hot position, varying relative amounts of the cold and hot supplies of the first and second input ports 44, 49 enter the mixing chamber 12. In the off position, a sealing surface (e.g. rubber or the like) moulded on the valve body 24 of the rotary valve 13 blocks fluid from entering the mixing chamber 12 from both the cold and hot supplies of the first and second input ports 44, 49, i.e. the radial inlet 22 overlies neither the first 44 nor the second input port 49. In the full cold position, the radial inlet 22 lies over the cold supply of the first input port 44 while the hot supply of the second input port 49 is still covered by the valve body 24. In the full hot position, the radial inlet 22 lies over the hot supply of the second input port 49, while the cold supply of the first input port 44, is covered by the valve body 24. In between these positions, the first and second input ports 44, 49 are partially covered by the valve body 24 and partially exposed by the radial inlet 22, to allow different relative proportions of cold and hot water from the first and second input ports 44, 49 to enter the mixing chamber 12. Rotation of the rotary valve 13 is achieved through rotation of the spring-loaded actuator 10.

The output supply pipe 4 is flexible and long enough to enable the spray unit 2 to be lifted away from the housing 5. The output supply pipe 4 slides up through the middle of the housing 5 to accommodate this movement. The flexible output supply pipe 4 runs within the hollow shaft 19 of the fixed housing 5. The spray unit 2 rests within the deck flange 6 of the fixed housing 5.

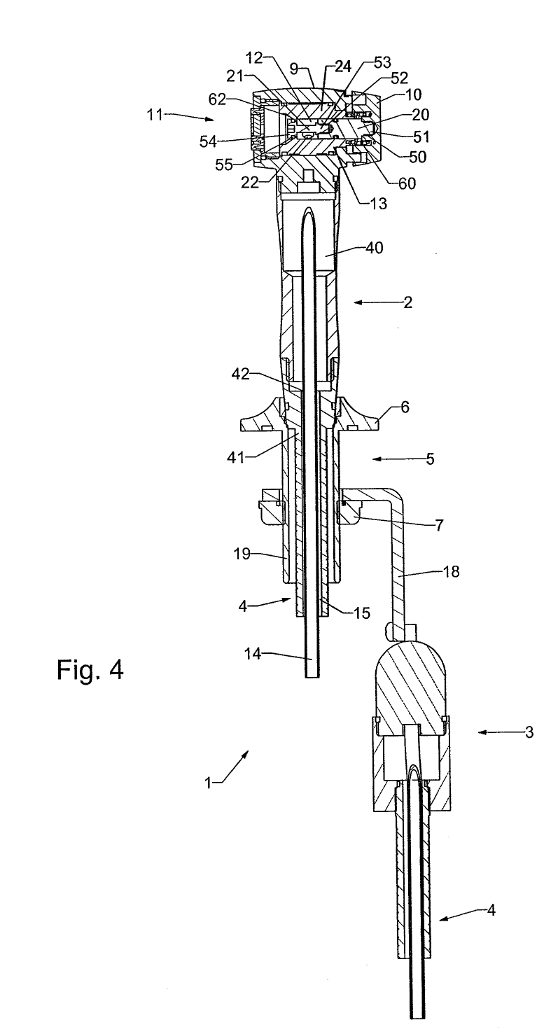

FIG. 4 shows a cross-sectional view of the spray device 1, which illustrates its inner workings. The spray head 9 of the spray unit 2 contains the mixing chamber 12. The rotary valve 13 controls fluid flow from the first and second input ports 44, 49 into the mixing chamber 12. The radial inlet 22 in the valve body 24 of the rotary valve 13 is shown. The spring loaded actuator 10 controls the output fluid flow through the nozzle 11. The spring loaded actuator 10 acts on a piston 20. The head 51 of the piston 20 is received by an indentation 50 in the spring loaded actuator 10. The piston 20 acts on a second piston 21. An indentation 52 in the first piston 20 receives the head 53 of the second piston 21. The second piston 21 has a T-shaped base 54. A spring 60 urges the actuator 10 out of the spray head 9 so that a sealing ring 55 seals against tapering walls 62 of the rotary valve 13, thereby isolating the mixing chamber 12. Depressing the spring loaded actuator 10 pushes the pistons 20 and 21 against the spring force towards the nozzle 11 of the spray head 9 so that the sealing ring 55 no longer seals the mixing chamber 12 and liquid from the mixing chamber 12 exits the mixing chamber 12 and flows out of the holes 42 of the nozzle 11.

Therefore, depression of the spring loaded actuator 10 leads to output fluid flow (expulsion of fluid) from the holes of the nozzle 11.

High water pressure may also act to open this valve by overcoming the spring force. To avoid this, a valve arrangement can be used where the water pressure acts with the spring force to close the valve. The user must then overcome both spring force and water pressure to activate the spray. Such valve arrangements are conventional.

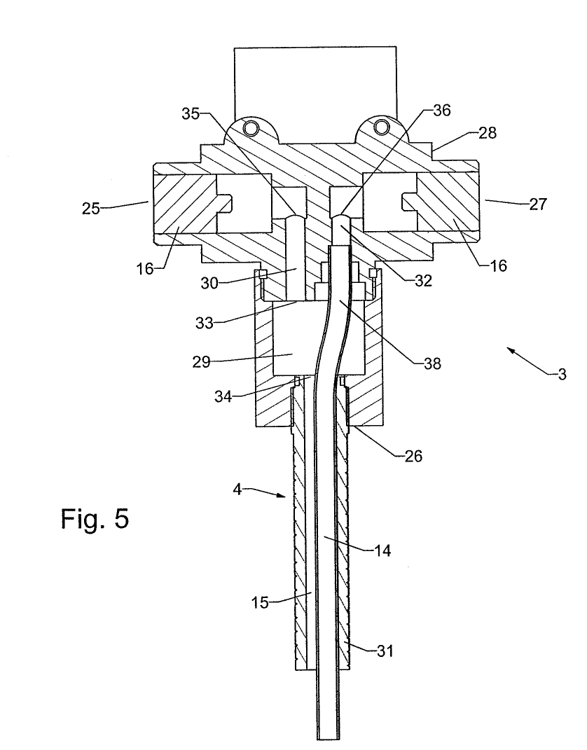

FIG. 5 shows a cross-sectional view of the liquid manifold 3, which illustrates its inner workings. Two input ports 25, 27 are inserted on opposite sides into a housing 28 of the manifold 3. The input ports 25, 27 are adapted to receive flexible hoses or pipes from respective hot or cold water supplies, e.g. mains water or hot/cold water supplies to an existing household water appliance. The input ports 25, 27 contain non-return valves 16, which allow fluid to flow into but not out of the manifold 3. The input port 25 is connected to a cold water supply and the input port 27 is connected to a hot water supply. The input ports connected to the cold and hot water supplies may be reversed so that the input port 25 is connected to a hot water supply and the input port 27 is connected to a cold water supply. The non-return valve 16 is connected to a tube 30 at an exit port 35. The tube 30 is connected to a collection chamber 29 at an input port 33 formed in the top of the collection chamber 29. The collection chamber 29 is connected to the first fluid feed 15 at an exit port 34 formed in the bottom of the collection chamber 29. In addition, a flexible conduit 31 is connected to the bottom of the collection chamber 29 around the exit port 34. The first fluid feed 15 runs within the flexible hose 31.

The non-return valve 16 is connected to a tube 32 via an exit port 36. The tube 32 connects to the second fluid feed 14. The second fluid feed 14 enters the collection chamber 29 through a port 38 formed in the top of the collection chamber 29 and exits the collection chamber 29 through the exit port 34. Thereby the second fluid feed 14 enters the first fluid feed 15.

The flexible fluid supply 4 consists of three parts: the flexible conduit 31 and the first and second fluid feeds 15, 14. The second fluid feed 14 runs within the first fluid feed 15, which in turn runs within the flexible hose 31. The flexible fluid supply 4 exits the manifold 3 via an output port 26 formed in the bottom of the housing 28.

The manifold 3 therefore produces a two-compartment fluid output wherein one compartment is enveloped within the other compartment.

What is claimed is:

1. A spray device for delivering a user-directable output fluid flow, the spray device having:
a spray unit detachably mountable on a work surface; and
a fluid supply arranged to deliver fluid to the spray unit, the fluid supply including first and second fluid feeds,
wherein the spray unit includes a mixing chamber which has first and second input ports connected to the first and second fluid feeds respectively and an output port, whereby fluid received in the mixing chamber from the input ports is mixed before exiting through the output port.

2. A spray device according to claim 1 including a mix controller arranged to adjustably control the mixing ratio of fluid receivable in the mixing chamber from the first and second input ports.

3. A spray device according to claim 1, wherein the spray unit has a spray nozzle which is connected to the output port of the mixing chamber.

4. A spray device according to claim 1, wherein the mix controller is a rotary valve arranged to vary the relative fluid flows received in the mixing chamber from the first and second input ports.

5. A spray device according to claim 4, wherein the rotary valve is movable to a fluid shut off position wherein the first and second input ports are isolated from the mixing chamber.

6. A spray device according to claim 2, wherein the mix controller includes a user adjustable actuator.

7. A spray device according to claim 1, wherein the spray unit includes a flow controller arranged to control output fluid flow.

8. A spray device according to claim 7, wherein the flow controller includes a spring loaded actuator.

9. A spray device according to claim 7, wherein the flow controller is arranged to adjustably control the mixing ratio of fluid receivable in the mixing chamber from the first and second input ports.

10. A spray device according claim 1, wherein the fluid supply is connected to a manifold which is arranged to supply independent fluid input flows to the first and second fluid feeds.

11. A spray device according to claim 10, wherein the first and second fluid feeds are transferred from the manifold to the spray unit in a flexible conduit.

12. A spray device according to claim 11, wherein each of the first and second fluid feeds is a flexible conduit in fluid communication with its respective input port at the mixing chamber.

13. A spray device according to claim 10, wherein the manifold is connected to a mains water supply.

14. A spray device according to claim 1, wherein the first and second fluid feeds comprise a compartmentalized conduit.

15. A mixer tap assembly having:
a mixer tap comprising a mixing chamber having a first input port and a second input port adapted to receive fluid from a first fluid feed and a second fluid feed respectively, and a fluid outlet arranged to deliver mixed fluid received from the mixing chamber; and
a spray device for delivering a user-directable output fluid flow, the spray device having a hand-held spray unit which has first and second input ports arranged to receive fluid from the first and second fluid feeds respectively,
wherein fluid received in the spray unit via the first and second input ports is mixed in the spray unit before being output, whereby mixing in the spray unit is independent of mixing in the mixer tap.

16. A mixer tap assembly according to claim 15, wherein the spray unit is detachably mountable on a work surface.
